(19) United States
(12) Patent Application Publication
(10) Pub. No.: US 2017/0099804 A1
(43) Pub. Date: Apr. 13, 2017

(54) SMART PET INTERACTIVE DEVICE

(71) Applicant: TAIWAN ANJIE ELECTRONICS CO., LTD, Hsinchu City (TW)

(72) Inventor: YU-MING CHANG, TAOYUAN CITY (TW)

(21) Appl. No.: 15/229,093

(22) Filed: Aug. 4, 2016

(30) Foreign Application Priority Data
Oct. 8, 2015 (TW) 104216263

(51) Int. Cl. A01K 5/02; G06F 3/14; G06F 3/0488; A01K 7/06

(52) U.S. Cl. CPC A01K 5/0233; A01K 7/06; G06F 3/14; G06F 3/04883; H04L 67/10

(57) ABSTRACT

A smart pet interactive device includes a cloud server, a smart communication device and a wireless pet interactive device. The smart communication device wireless is connected to the cloud server and equipped with an interactive module corresponding to the cloud server. The wireless pet interactive device wireless is connected to the cloud server and placed in a living space where at least one pet lives. The smart communication device is connected to the cloud server through the interactive module to control the wireless pet interactive device to provide food to the at least one pet, capture a first image of the living space, send the first image to the smart communication device through the cloud server, and control the interactive module to display the first image, thereby effectuating interaction between a pet and its owner.

### CROSS-REFERENCE TO RELATED APPLICATION

This non-provisional application claims priority under 35 U.S.C. §119(a) on Patent Application No(s).104216263 filed in Taiwan, R.O.C. on Oct. 8, 2015, the entire contents of which are hereby incorporated by reference.

### FIELD OF THE INVENTION

The present invention relates to interactive devices and, more particularly, to a smart pet interactive device.

### BACKGROUND OF THE INVENTION

Unlike their ancient counterparts, contemporary pets are indispensable companions to we human beings as a result of our high living standards and aging populations. An even bigger change in pet keeping history is that, pet owners today are increasingly humane in treating pets, for example, seeing pets as their family members, and taking care of pets at incredibly high prices in both spiritual and physical dimensions. Hence, pet keeping nowadays contributes to two commercially lucrative arenas, namely pet interactive toys and pet foods.

Passionate pet owners who are at work or traveling on business seldom hesitate to take a look at or play with the pets they keep at home, nor do caring pet owners ever feel at ease with the pets' feeding, appetite, and health. In this regard, the pet's signs and symptoms, such as lethargy, appetite and body weight, are indicative of the pets' health. Referring to FIG. 1, a conventional automatic feed device 10 is stationary and thus fails to serve an interactive feeding purpose, satisfy the need to feed multiple pets, and simulate on-site feeding.

Accordingly, the present invention provides a smart pet interactive device to overcome the aforesaid drawbacks of the prior art.

### SUMMARY OF THE INVENTION

It is an objective of the present invention to provide a smart pet interactive device wirelessly connected to a smart communication device through an application server and a wireless pet interactive device to control the wireless pet interactive device to supply food to pets, capture images of the pets' living space, and thereby enable the pet owner to interact with the pets and take care of the pets whether at home or away from home.

In order to achieve the above and other objectives, the present invention provides a smart pet interactive device which comprises a cloud server, a smart communication device and a wireless pet interactive device. The smart communication device wireless is connected to the cloud server and equipped with an interactive module of the cloud server. The smart communication device displays at least one feed command. The smart communication device sends at least one first wireless signal to the cloud server with the interactive module according to the feed command as soon as the feed command is touched. The cloud server generates at least one feed signal according to the first wireless signal. The wireless pet interactive device wireless is connected to the cloud server and placed in a living space. The living space accommodates at least one pet. The wireless pet interactive device comprises a first wireless interface, a first processor, at least one food dispenser and a first image-capturing lens. The first processor is electrically connected to the first wireless interface, the food dispenser and the first image-capturing lens. The first wireless interface wireless is connected to the cloud server so that the first processor receives the feed signal through the first wireless interface. The food dispenser stores food and is disposed above at least one first receiving chamber. The first processor controls the food dispenser to deliver food to the first receiving chamber according to the feed signal, so as to feed the food to pets. The first image-capturing lens captures a first image of the living space, and the first processor sends the first image to the smart communication device through the first wireless interface and the cloud server consecutively and displays the first image with the interactive module.

### BRIEF DESCRIPTION OF THE DRAWINGS

FIG. 1 (PRIOR ART) is a perspective view of a conventional automatic feed device;

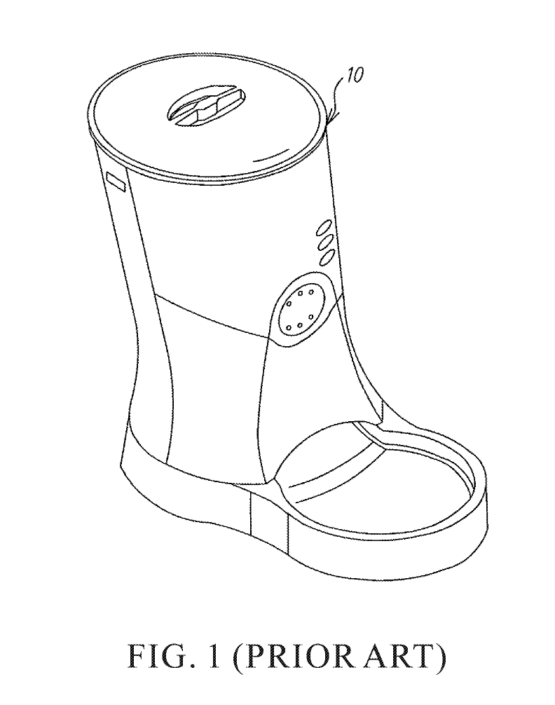

FIG. 2 is a block diagram of a smart pet interactive device according to an embodiment of the present invention; and

FIG. 3 is a structural schematic view of the smart pet interactive device according to an embodiment of the present invention.

### DETAILED DESCRIPTION OF THE PREFERRED EMBODIMENTS

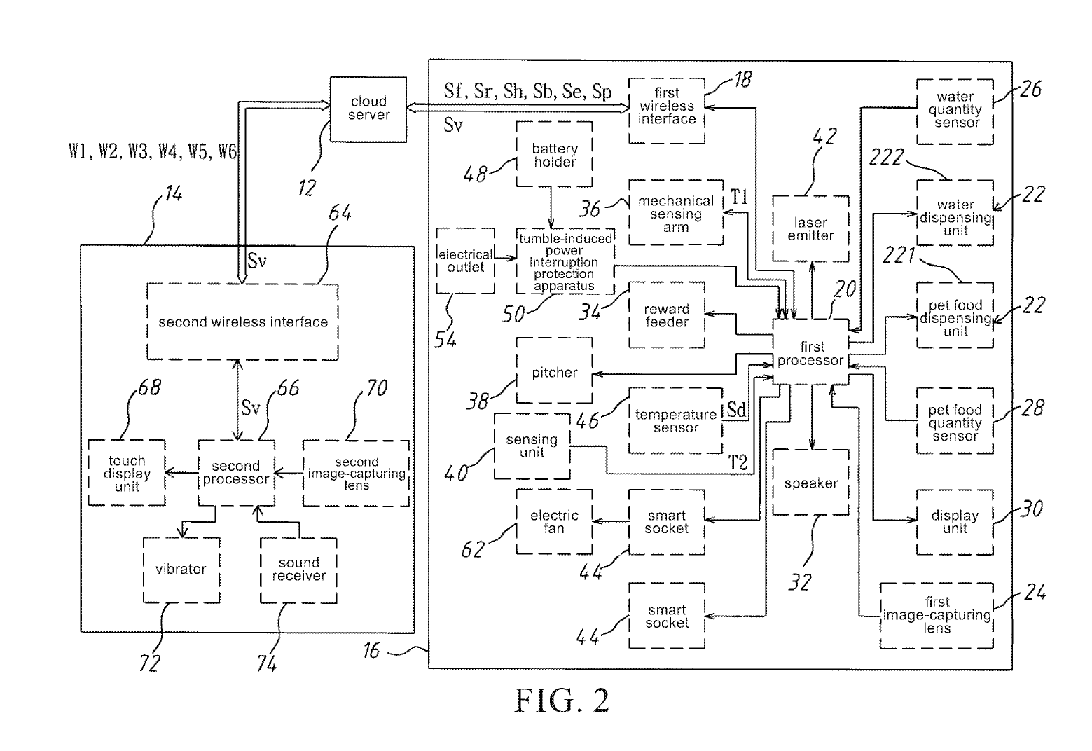

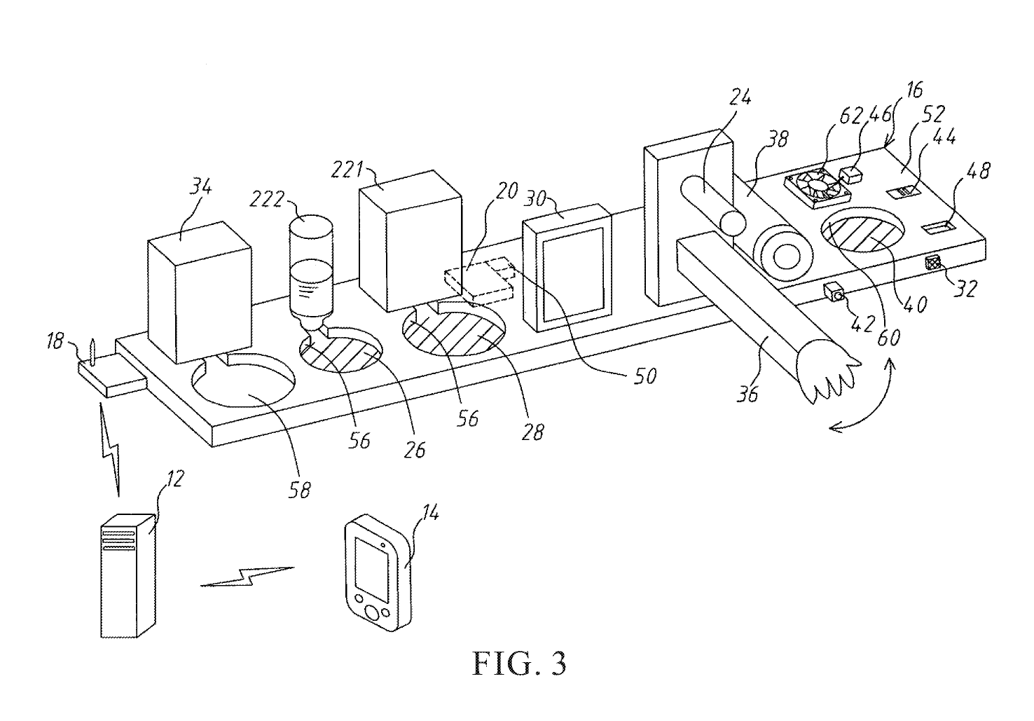

Referring to FIG. 2 and FIG. 3, according to the present invention, a smart pet interactive device comprises a cloud server 12, a smart communication device 14 and a wireless pet interactive device 16. The smart communication device 14 is a tablet, a smartphone, a desktop or a notebook computer. The smart communication device 14 is wirelessly connected to the cloud server 12 and equipped with an interactive module of the cloud server 12. The interactive module operates by an App, but the present invention is not limited thereto. The App is developed by a third-party software developer and presented on a sales platform so that it can be downloaded to the smart communication device 14 and installed thereon. The smart communication device 14 displays at least one feed command's icon. As soon as a user of the smart communication device 14 touches the feed command's icon, the smart communication device 14 sends at least one first wireless signal W1 with the interactive module according to the feed command to the cloud server 12 so that the cloud server 12 generates at least one feed signal Sf according to the first wireless signal W1. The wireless pet interactive device 16 is wirelessly connected to the cloud server 12 and placed in a living space. The living space accommodates at least one pet, such as a cat or a dog. The wireless pet interactive device 16 comprises a first wireless interface 18, a first processor 20, at least one food dispenser 22, a first image-capturing lens 24, a water quantity sensor 26, a pet food quantity sensor 28, a display unit 30, a speaker 32, a reward feeder 34, a mechanical sensing arm 36, a pitcher 38, a sensing unit 40, a laser emitter 42, at least one smart socket 44, a temperature sensor 46, a battery holder 48, a tumble-induced power interruption protection apparatus 50 and a base 52. The first processor 20 is electrically connected to the first wireless interface 18, the food dispenser 22, the first image-capturing lens 24, the water quantity sensor 26, the pet food quantity sensor 28, the display unit 30, the speaker 32, the reward feeder 34, the mechanical sensing arm 36, the pitcher 38, the sensing unit 40, the laser emitter 42, the smart socket 44 and the temperature sensor 46 and electrically connected to the battery holder 48 and an electrical outlet 54 through the tumble-induced power interruption protection apparatus 50. The first processor 20, the first wireless interface 18, the food dispenser 22, the first image-capturing lens 24, the water quantity sensor 26, the pet food quantity sensor 28, the display unit 30, the speaker 32, the reward feeder 34, the mechanical sensing arm 36, the pitcher 38, the sensing unit 40, the laser emitter 42, the smart socket 44, the temperature sensor 46, the tumble-induced power interruption protection apparatus 50 and the battery holder 48 are disposed on the base 52. At least one first receiving chamber 56, a second receiving chamber 58 and a third receiving chamber 60 are disposed on the base 52. In this embodiment, the food dispenser 22, the first receiving chamber 56 and the smart socket 44 are provided in the numbers of two, two, and two, respectively. The two food dispensers 22 are a pet food dispensing unit 221 and a water dispensing unit 222, respectively, which dispense food, namely pet food and water. The pet food dispensing unit 221 and the water dispensing unit 222 are disposed above the two first receiving chambers 56, respectively.

The first wireless interface 18 is wirelessly connected to the cloud server 12. The first processor 20 receives the feed signal Sf through the first wireless interface 18. Then, the first processor 20 controls, automatically or predecidedly, the pet food dispensing unit 221 and the water dispensing unit 222 to supply pet food and water to the two first receiving chambers 56, respectively, according to the feed signal Sf, so that the pet owner can take care of the pets, regardless of whether the pet owner is at home or away from home. The first image-capturing lens 24 captures a first image of a living space to observe at any time what is going on around the pets and what the pets are doing. The first processor 20 sends the first image, through the first wireless interface 18 and the cloud server 12 consecutively, to the smart communication device 14 so that the first image is displayed on the smart communication device 14 through the interactive module. The water quantity sensor 26 and the pet food quantity sensor 28 are disposed in the two first receiving chambers 56, respectively, to sense the amounts of the water and pet food which remain (hereinafter referred to as “reminder levels”, respectively. The water quantity sensor 26 and the pet food quantity sensor 28 send, through the first processor 20, the first wireless interface 18 and the cloud server 12 consecutively, data indicative of the reminder levels to the smart communication device 14 so that the data indicative of the reminder levels is displayed with the interactive module, so as for the pet owner to detect the pets' feeding status, and in consequence the pets' feeding status thus detected will be taken into account in controlling the body weight of the pets and adjusting the quantity of pet food to be dispensed next time. The display unit 30 of the wireless pet interactive device 16 is a liquid crystal display. The smart communication device 14 displays a display command's icon. As soon as the user of the smart communication device 14 touches the display command's icon, the smart communication device 14 captures a second image of the pet owner and sends the second image to the display unit 30 through the cloud server 12, the first wireless interface 18 and the first processor 20 consecutively with the interactive module according to the display command so that the second image is displayed on the display unit 30, thereby allowing the pet owner to interact with the pets by remote control. The smart communication device 14 displays a call command's icon. As soon as the user of the smart communication device 14 touches the call command's icon, the smart communication device 14 sends a sound file to the speaker 32 through the cloud server 12, the first wireless interface 18 and the first processor 20 consecutively with the interactive module according to the call command. The sound file is either produced externally or is built-in. If the sound file is produced externally, it will be used to train the pets to sit, perform a handshake, and lie on the ground.

The reward feeder 34 stores reward food, as opposed to pet food and water. The reward food is usually the pets' favorite food, such as dog cookies. The reward feeder 34 is disposed above the second receiving chamber 58. The smart communication device 14 displays a reward command's icon. As soon as the user of the smart communication device 14 touches the reward command's icon, the smart communication device 14 sends a second wireless signal W2 to the cloud server 12 through the interactive module according to the reward command. Then, the cloud server 12 generates a reward signal Sr according to the second wireless signal W2. The first processor 20 receives the reward signal Sr through the first wireless interface 18, so as to control the reward feeder 34 to deliver the reward food to the second receiving chamber 58, thereby feeding the reward food to the pets. The smart communication device 14 displays a handshake command's icon. As soon as the user of the smart communication device 14 touches the handshake command's icon, the smart communication device 14 sends a third wireless signal W3 to the cloud server 12 with the interactive module according to the handshake command. Then, the cloud server 12 generates a handshake signal Sh according to the third wireless signal W3. The first processor 20 receives the handshake signal Sh through the first wireless interface 18, so as to control the mechanical sensing arm 36 to shake. As soon as the mechanical sensing arm 36 comes into contact with one of the pets, it will send a first trigger signal T1 to the first processor 20. Then, in response to the first trigger signal T1, the first processor 20 controls the reward feeder 34 to deliver the reward food to the second receiving chamber 58 so as to reward the pet with the reward food for following commands given by the pet owner, thereby enhancing the interaction the pet and the pet owner. The first processor 20 generates a wireless vibration signal Sv according to the first trigger signal T1 and sends the wireless vibration signal Sv to the smart communication device 14 through the first wireless interface 18 and the cloud server 12 consecutively. Then, the smart communication device 14 vibrates according to the wireless vibration signal Sv. The smart communication device 14 displays a pitch command's icon. As soon as the user of the smart communication device 14 touches the pitch command's icon, the smart communication device 14 sends a fourth wireless signal W4 to the cloud server 12 with the interactive module according to the pitch command. Then, the cloud server 12 generates a pitch signal Sb according to the fourth wireless signal W4. Afterward, the first processor 20 receives the pitch signal Sb through the first wireless interface 18, so as to control the pitcher 38 to throw a ball. The sensing unit 40 is disposed in the third receiving chamber 60. After coming into contact with the ball, the sensing unit 40 sends a second trigger signal T2 to the first processor 20. The first processor 20 controls, according to the second trigger signal T2, the reward feeder 34 to deliver the reward food to the second receiving chamber 58, so as to feed the reward food to the pets.

The smart communication device 14 displays a frolic command's icon. As soon as the user of the smart communication device 14 touches the frolic command's icon, the smart communication device 14 sends a fifth wireless signal W5 to the cloud server 12 with the interactive module according to the frolic command. Then, the cloud server 12 generates a frolic signal Se according to the fifth wireless signal W5. Afterward, the first processor 20 receives the frolic signal Se through the first wireless interface 18, so as to control the emission direction of the laser emitter 42 and drive the laser emitter 42 to emit a laser point whereby the pets play with each other and chase after each other, thereby enhancing the interaction between the pet owner and the pets. One said smart socket 44 is electrically connected to an electric appliance, such as an electric fan 62, whereas another said smart socket 44 enables the user to get connected to another switch device and switch it on or off through the smart communication device 14 at any time. The smart communication device 14 displays a power supply command's icon. As soon as the user of the smart communication device 14 touches the power supply command's icon, the smart communication device 14 sends a sixth wireless signal W6 to the cloud server 12 with the interactive module according to the power supply command. Then, the cloud server 12 generates a power supply signal Sp according to the sixth wireless signal W6. The first processor 20 receives the power supply signal Sp through the first wireless interface 18, so as to control the smart sockets 44 to supply electric power to the electric fan 62. The temperature sensor 46 detects an ambient temperature and sends a heat dissipation signal Sd to the first processor 20 as soon as the detected ambient temperature reaches a predetermined temperature. The first processor 20 turns on the electric fan 62 according to the heat dissipation signal Sd to enable the pets to dissipate heat better and thus gives comfort to the pets.

The battery holder 48 holds therein a battery. The first processor 20 receives power from an electrical outlet or the battery through the tumble-induced power interruption protection apparatus 50. The first processor 20, the base 52, the battery holder 48 and the tumble-induced power interruption protection apparatus 50 tilt by a predetermined angle to cause an open circuit to the tumble-induced power interruption protection apparatus 50 so that the tumble-induced power interruption protection apparatus 50 sends an alert message to the smart communication device 14 through the first processor 20, the first wireless interface 18 and the cloud server 12 consecutively. Then, the alert message is displayed on the smart communication device 14 with the interactive module. Therefore, if the pets knock over the base 52 and components thereon out of curiosity or for some reason, the tumble-induced power interruption protection apparatus 50 will create an open circuit and send the alert message to the smart communication device 14 to inform the pet owner of the event, so as to not only protect the wireless pet interactive device 16 against any damage but also prevent the pet food and water from overflowing.

The smart communication device 14 further comprises a second wireless interface 64, a second processor 66, a touch display unit 68, a second image-capturing lens 70, a vibrator 72 and a sound receiver 74. The second processor 66 is electrically connected to the second wireless interface 64, the touch display unit 68, the second image-capturing lens 70, the vibrator 72 and the sound receiver 74. The second processor 66 is equipped with an interactive module. The touch display unit 68 displays icons of a feed command, a call command, a reward command, a display command, a handshake command, a pitch command, a frolic command and a power supply command, respectively. As soon as the user touches the feed command's icon on the touch display unit 68, the second processor 66 sends the first wireless signal W1 to the cloud server 12 through the second wireless interface 64 with the interactive module according to the feed command. As soon as the user touches the call command's icon on the touch display unit 68, the second processor 66 sends a sound file to the cloud server 12 through the second wireless interface 64 with the interactive module according to the call command. As soon as the user touches the reward command's icon on the touch display unit 68, the second processor 66 sends the second wireless signal W2 to the cloud server 12 through the second wireless interface 64 with the interactive module according to the reward command. As soon as the user touches the display command's icon on the touch display unit 68, the second processor 66 drives the second image-capturing lens 70 to capture the second image and sends the second image to the cloud server 12 through the second wireless interface 64 with the interactive module according to the display command. As soon as the user touches the handshake command's icon on the touch display unit 68, the second processor 66 sends the third wireless signal W3 to the cloud server 12 through the second wireless interface 64 with the interactive module according to the handshake command. As soon as the user touches the pitch command's icon on the touch display unit 68, the second processor 66 sends the fourth wireless signal W4 to the cloud server 12 through the second wireless interface 64 with the interactive module according to the pitch command. As soon as the user touches the frolic command's icon on the touch display unit 68, the second processor 66 sends the fifth wireless signal W5 to the cloud server 12 through the second wireless interface 64 with the interactive module according to the frolic command. As soon as the user touches the power supply command's icon on the touch display unit 68, the second processor 66 sends the sixth wireless signal W6 to the cloud server 12 through the second wireless interface 64 with the interactive module according to the power supply command.

The second processor 66 receives the wireless vibration signal Sv from the cloud server 12 through the second wireless interface 64, so as to drive the vibrator 72 to vibrate. The sound receiver 74 receives an external sound, such as the pet owner's calling voice, to produce an external sound file which will then be stored in the second processor 66, so as for the pet owner to talk to the pets interactively. The second processor 66 receives the first image, data indicative of the reminder levels of water and pet food and the alert message through the second wireless interface 64. Then, the first image, the data indicative of the reminder levels of water and pet food and the alert message are displayed on the touch display unit 68 with the interactive module.

The operation of the present invention is described below. As soon as the user touches the feed command's icon on the touch display unit 68, the second processor 66 sends the first wireless signal W1 to the cloud server 12 through the second wireless interface 64 with the interactive module according to the feed command. Then, the cloud server 12 generates at least one feed signal Sf according to the first wireless signal W1. Afterward, the first processor 20 receives the feed signal Sf through the first wireless interface 18. The first processor 20 controls, automatically or predecidedly, the pet food dispensing unit 221 and the water dispensing unit 222 to supply pet food and water to the two first receiving chambers 56, respectively, according to the feed signal Sf, so as to feed the pet food and water to the pets. The water quantity sensor 26 and the pet food quantity sensor 28 sense the reminder levels of the water and pet food, respectively. The data indicative of the reminder levels is sent to the second processor 66 through the first processor 20, the first wireless interface 18, the cloud server 12 and the second wireless interface 64 consecutively and displayed on the touch display unit 68 with the interactive module.

As soon as the user touches the call command's icon on the touch display unit 68, the second processor 66 sends a sound file to the cloud server 12 through the second wireless interface 64 with the interactive module according to the call command. Then, the cloud server 12 sends the sound file to the speaker 32 through the first wireless interface 18 and the first processor 20 consecutively to produce a sound. As soon as the user touches the reward command's icon on the touch display unit 68, the second processor 66 sends the second wireless signal W2 to the cloud server 12 through the second wireless interface 64 with the interactive module according to the reward command. The cloud server 12 generates the reward signal Sr according to the second wireless signal W2. The first processor 20 receives the reward signal Sr through the first wireless interface 18 and controls the reward feeder 34 to deliver the reward food to the second receiving chamber 58, so as to feed the reward food to the pets.

As soon as the user touches the display command's icon on the touch display unit 68, the second processor 66 drives the second image-capturing lens 70 to capture the second image and sends the second image to the cloud server 12 through the second wireless interface 64 with the interactive module according to the display command. Then, the cloud server 12 sends the second image to the display unit 30 through the first wireless interface 18 and the first processor 20, so as to display the second image on the display unit 30. The first image-capturing lens 24 also captures the first image of the pets' living space. Then, the first processor 20 sends the first image to the second processor 66 through the first wireless interface 18, the cloud server 12 and second wireless interface 64 consecutively, to display the first image on the touch display unit 68 with the interactive module.

As soon as the user touches the handshake command's icon on the touch display unit 68, the second processor 66 sends the third wireless signal W3 to the cloud server 12 through the second wireless interface 64 with the interactive module according to the handshake command. The cloud server 12 generates the handshake signal Sh according to the third wireless signal W3. The first processor 20 receives the handshake signal Sh through the first wireless interface 18, so as to control the mechanical sensing arm 36 to shake. As soon as it comes into contact with the pets, the mechanical sensing arm 36 generates and sends the first trigger signal T1 to the first processor 20. Then, the first processor 20 controls the reward feeder 34 to deliver the reward food to the second receiving chamber 58 according to the first trigger signal T1, so as to feed the reward food to the pets. The first processor 20 generates the wireless vibration signal Sv according to the first trigger signal T1 and thus sends the wireless vibration signal Sv to the second processor 66 through the first wireless interface 18, the cloud server 12 and the second wireless interface 64 consecutively. Then, the second processor 66 drives the vibrator 72 to vibrate according to the wireless vibration signal Sv.

As soon as the user touches the pitch command's icon on the touch display unit 68, the second processor 66 sends the fourth wireless signal W4 to the cloud server 12 through the second wireless interface 64 with the interactive module according to the pitch command. Then, the cloud server 12 generates a pitch signal Sb according to the fourth wireless signal W4. The first processor 20 receives the pitch signal Sb through the first wireless interface 18, so as to control the pitcher 38 to throw a ball. As soon as one of the pets places the ball in the third receiving chamber 60 in a manner that the ball comes into contact with the sensing unit 40, the sensing unit 40 sends the second trigger signal T2 to the first processor 20. Then, the first processor 20 controls, according to the second trigger signal T2, the reward feeder 34 to deliver the reward food to the second receiving chamber 58, so as to feed the reward food to the pets.

As soon as the user touches the frolic command's icon on the touch display unit 68, the second processor 66 sends the fifth wireless signal W5 to the cloud server 12 through the second wireless interface 64 with the interactive module according to the frolic command. Then, the cloud server 12 generates a frolic signal Se according to the fifth wireless signal W5. The first processor 20 receives the frolic signal Se through the first wireless interface 18, so as to control the emission direction of the laser emitter 42 and drive the laser emitter 42 to emit a laser point, thereby allowing the pet owner to play with the pets.

As soon as the user touches the power supply command's icon on the touch display unit 68, the second processor 66 sends the sixth wireless signal W6 to the cloud server 12 through the second wireless interface 64 with the interactive module according to the power supply command. The cloud server 12 generates a power supply signal Sp according to the sixth wireless signal W6. The first processor 20 receives the power supply signal Sp through the first wireless interface 18, so as to control the smart sockets 44 to supply electric power to an electric appliance. The first processor 20, the base 52, the battery holder 48 and the tumble-induced power interruption protection apparatus 50 tilt by a predetermined angle to cause an open circuit to the tumble-induced power interruption protection apparatus 50 so as for an alert message to be sent from the tumble-induced power interruption protection apparatus 50 to the second processor 66 through the first processor 20, the first wireless interface 18, the cloud server 12 and second wireless interface 64 consecutively, and displayed on the touch display unit 68 with the interactive module.

In conclusion, according to the present invention, a smart communication device is wirelessly connected to a wireless pet interactive device through an application server to control the wireless pet interactive device to provide various functions and interact with pets so that a pet owner can take care of the pets whether at home or away from home.

What is claimed is:

1. A smart pet interactive device, comprising:
a cloud server;
a smart communication device wirelessly connected to the cloud server, equipped with an interactive module of the cloud server, adapted to display at least one feed command, and adapted to send at least one first wireless signal to the cloud server with the interactive module according to the feed command as soon as the feed command is touched, thereby allowing the cloud server to generate at least one feed signal according to the first wireless signal; and
a wireless pet interactive device wirelessly connected to the cloud server and placed in a living space providing accommodation to at least one pet, the wireless pet interactive device comprising:
a first wireless interface wirelessly connected to the cloud server;
a first processor electrically connected to the first wireless interface to receive the feed signal;
at least one food dispenser electrically connected to the first processor, adapted to store food, and disposed above at least one first receiving chamber, allowing the first processor to control the food dispenser to deliver the food to the first receiving chamber according to the feed signal, so as to feed the food to the pets; and
a first image-capturing lens electrically connected to the first processor and adapted to capture a first image of the living space, allowing the first image to be sent from the first processor to the smart communication device through the first wireless interface and the cloud server consecutively and displayed with the interactive module.

2. The smart pet interactive device of claim 1, wherein the food dispenser is provided in a number of two and the first receiving chamber in a number of two, with the two food dispensers being a pet food dispensing unit and a water dispensing unit, respectively, and the food being pet food and water, allowing the pet food dispensing unit and the water dispensing unit to be disposed above the two first receiving chambers, respectively.

3. The smart pet interactive device of claim 2, wherein the wireless pet interactive device further comprising:
a water quantity sensor; and
a pet food quantity sensor electrically connected to the water quantity sensor, wherein the pet food quantity sensor and the water quantity sensor are disposed in the two first receiving chambers, respectively, to sense reminder levels of the water and the pet food, send data indicative of the reminder levels to the smart communication device through the first processor, the first wireless interface and the cloud server consecutively, and display the data indicative of the reminder levels with the interactive module.

4. The smart pet interactive device of claim 1, wherein the wireless pet interactive device further comprises a display unit electrically connected to the first processor, whereas the smart communication device displays a display command, captures a second image of the pet owner as soon as the display command is touched, and sends the second image to the display unit through the cloud server, the first wireless interface and the first processor consecutively with the interactive module according to the display command, so as to display the second image.

5. The smart pet interactive device of claim 4, wherein the display unit is a liquid crystal display.

6. The smart pet interactive device of claim 4, wherein the wireless pet interactive device further comprises a speaker electrically connected to the first processor, whereas the smart communication device displays a call command and sends a sound file to the speaker through the cloud server, the first wireless interface and the first processor consecutively with the interactive module according to the call command as soon as the call command is touched, so as for the speaker to produce a sound.

7. The smart pet interactive device of claim 6, wherein the sound file is produced externally or built-in.

8. The smart pet interactive device of claim 6, wherein the wireless pet interactive device further comprises a reward feeder electrically connected to the first processor, adapted to store reward food, and disposed above a second receiving chamber, whereas the smart communication device displays a reward command and sends a second wireless signal to the cloud server with the interactive module according to the reward command as soon as the reward command is touched, so as to allow the cloud server to generate a reward signal according to the second wireless signal, enable the first processor to receive the reward signal through the first wireless interface, and control the reward feeder to deliver the reward food to the second receiving chamber, thereby feeding the reward food to the pets.

9. The smart pet interactive device of claim 8, wherein the wireless pet interactive device further comprises a mechanical sensing arm electrically connected to the first processor, whereas the smart communication device displays a handshake command and sends a third wireless signal to the cloud server with the interactive module according to the handshake command as soon as the handshake command is touched, so as to allow the cloud server to generate a handshake signal according to the third wireless signal, enable the first processor to receive the handshake signal through the first wireless interface, and control the mechanical sensing arm to shake, wherein the mechanical sensing arm sends a first trigger signal to the first processor as soon as the mechanical sensing arm comes into contact with the pets, wherein the first processor controls the reward feeder to deliver the reward food to the second receiving chamber according to the first trigger signal and feed the reward food to the pets, generates a wireless vibration signal according to the first trigger signal, and sends the wireless vibration signal to the smart communication device through the first wireless interface and the cloud server consecutively, thereby allowing the smart communication device to vibrate according to the wireless vibration signal.

10. The smart pet interactive device of claim 8, wherein the wireless pet interactive device further comprising:
a pitcher electrically connected to the first processor, wherein the smart communication device displays a pitch command and sends a fourth wireless signal to the cloud server with the interactive module according to the pitch command as soon as the pitch command is touched, and the cloud server generates a pitch signal according to the fourth wireless signal so that the first processor receives the pitch signal through the first wireless interface, so as to control the pitcher to throw a ball; and
a sensing unit disposed in a third receiving chamber, electrically connected to the first processor, and adapted to send a second trigger signal to the first processor as soon as the sensing unit comes into contact with the ball, wherein the first processor controls the reward feeder to deliver the reward food to the second receiving chamber according to the second trigger signal, so as to feed the reward food to the pets.

11. The smart pet interactive device of claim 9, wherein the smart communication device further comprising:
a second wireless interface;
a second processor electrically connected to the second wireless interface and equipped with the interactive module;
a touch display unit electrically connected to the second processor and adapted to display the display command, the call command and the handshake command so that the second processor sends the sound file to the cloud server through the second wireless interface with the interactive module according to the call command as soon as the call command is touched;
a second image-capturing lens electrically connected to the second processor so that the second processor drives the second image-capturing lens to capture the second image as soon as the display command is touched and sends the second image to the cloud server through the second wireless interface with the interactive module according to the display command; and
a vibrator electrically connected to the second processor so that the second processor sends the third wireless signal to the cloud server through the second wireless interface with the interactive module according to the handshake command as soon as the handshake command is touched and receives the wireless vibration signal from the cloud server through the second wireless interface, so as to drive the vibrator to vibrate.

12. The smart pet interactive device of claim 1, wherein the wireless pet interactive device further comprises a laser emitter electrically connected to the first processor, whereas the smart communication device displays a frolic command and sends a fifth wireless signal to the cloud server with the interactive module according to the frolic command as soon as the frolic command is touched, and the cloud server generates a frolic signal according to the fifth wireless signal, so as for the first processor to receive the frolic signal through the first wireless interface, control an emission direction of the laser emitter, and drive the laser emitter to emit a laser point.

13. The smart pet interactive device of claim 1, wherein the wireless pet interactive device further comprises at least one smart socket electrically connected to the first processor and an electric appliance, whereas the smart communication device displays a power supply command and sends a sixth wireless signal to the cloud server with the interactive module according to the power supply command as soon as the power supply command is touched, and the cloud server generates a power supply signal according to the sixth wireless signal, so as for the first processor to receive the power supply signal through the first wireless interface and control the at least one smart socket to supply electric power to the electric appliance.

14. The smart pet interactive device of claim 13, wherein the electric appliance is an electric fan.

15. The smart pet interactive device of claim 14, wherein the wireless pet interactive device further comprises a temperature sensor electrically connected to the first processor and adapted to detect an ambient temperature and send a heat dissipation signal to the first processor as soon as the detected ambient temperature reaches a predetermined temperature, allowing the first processor to turn on the electric fan according to the heat dissipation signal.

16. The smart pet interactive device of claim 1, wherein the first processor is electrically connected to an electrical outlet and a battery holder for holding a battery and adapted to receive power from one of the electrical outlet and the battery.

17. The smart pet interactive device of claim 16, wherein the wireless pet interactive device further comprises a tumble-induced power interruption protection apparatus, whereas the first processor is electrically connected to the electrical outlet and the battery holder through the tumble-induced power interruption protection apparatus, wherein the first processor, the tumble-induced power interruption protection apparatus and the battery holder are disposed on a base, wherein the first processor, the base, the battery holder and the tumble-induced power interruption protection apparatus tilt by a predetermined angle to cause an open circuit to the tumble-induced power interruption protection apparatus so that an alert message is sent to the smart communication device through the first processor, the first wireless interface and the cloud server consecutively and displayed with the interactive module.

18. The smart pet interactive device of claim 1, wherein the smart communication device is one of a tablet, a smartphone, a desktop and a notebook computer.
